(19) United States
(12) Patent Application Publication
(10) Pub. No.: US 2025/0252844 A1
(43) Pub. Date: Aug. 7, 2025

(54) WORK ASSISTANCE METHOD AND WORK ASSISTANCE SYSTEM

(71) Applicant: SCREEN Holdings Co., Ltd., Kyoto (JP)

(72) Inventors: Hunghsiu YEN, Kyoto-shi (JP); Shinji SHIMIZU, Kyoto-shi (JP)

(21) Appl. No.: 19/011,507

(22) Filed: Jan. 6, 2025

(30) Foreign Application Priority Data
Feb. 2, 2024 (JP) 2024-014706

(51) Int. Cl. G08B 25/01; G08B 7/06; G08B 21/02; G10L 15/183; H04R 1/32

(52) U.S. Cl. CPC G08B 25/016; G08B 7/06; G08B 21/02; G10L 15/183; H04R 1/326

(57) ABSTRACT

Recording data in various environments is collected in a work area, and an acoustic model is constructed by machine learning using an acoustic feature extracted from the recording data as learning data. When a worker wearing smart glasses to which the acoustic model has been mounted performs work in the work area, an automated guided vehicle travels in the work area while emitting a warning sound. The smart glasses detect the warning sound emitted by the automated guided vehicle by inputting the acoustic feature extracted from the collected data of sounds into the acoustic model and issue a warning. Even when the worker is not aware of the warning sound emitted by the automated guided vehicle, the worker can surely recognize the automated guided vehicle by the warning issued by the smart glasses.

### BACKGROUND OF THE INVENTION

### Field of the Invention

The present invention relates to work assistance methods and work assistance systems when a worker performs work in a work area where industrial equipment, such as a substrate processing apparatus that performs predetermined processing on a substrate, is positioned and an automated guided vehicle travels. Examples of the substrate on which processing is performed by the substrate processing apparatus include a semiconductor substrate, a substrate for liquid crystal display, a substrate for flat panel display (FPD), a substrate for optical disc, a substrate for magnetic disk, and a substrate for solar cell.

### Description of the Background Art

A substrate processing apparatus that performs various types of processing on a substrate, such as a semiconductor substrate, has conventionally been used in a semiconductor device manufacturing process. As the substrate processing apparatus, a substrate cleaning apparatus, a heat treatment apparatus, an inspection apparatus, and the like are used. A large number of substrate processing apparatuses are typically orderly arranged in a spacious cleanroom. Maintenance is performed on these substrate processing apparatuses at an appropriate timing. US 2021/0264016 discloses that a large number of substrate processing apparatuses are arranged in a cleanroom at a relatively high density, and maintenance is performed on the substrate processing apparatuses.

In the cleanroom where the large number of substrate processing apparatuses are arranged, an automated guided vehicle (AGV) transports a container containing substrates. Japanese Patent Application Laid-Open No. 2020-189732 discloses that an automated guided vehicle to which a container containing substrates has been mounted automatically travels in a cleanroom along a predetermined path. The automated guided vehicle transfers unprocessed substrates to substrate processing apparatuses and retrieves processed substrates from the substrate processing apparatuses. In the cleanroom, a worker who performs operation and maintenance on the substrate processing apparatuses also performs work. That is to say, the worker performs work in an environment in which the automated guided vehicle travels in the cleanroom.

There are not only the large number of substrate processing apparatuses but also tools, parts, and the like in the cleanroom, so that an environment in the cleanroom is a visually complex environment. The worker who performs work in the cleanroom is thus less aware of surroundings and movement of an object due to visual fatigue and might hit the automated guided vehicle.

To avoid such danger, the automated guided vehicle emits a warning sound during travel. However, robots, pumps, and the like of the substrate processing apparatuses arranged in the cleanroom also make noise, and, when the automated guided vehicle keeps emitting the warning sound in such a situation, the worker concentrating on work might get used to the warning sound and sometimes does not recognize the automated guided vehicle. Furthermore, when the worker performs work near a robot and a pump, the worker sometimes does not hear the warning sound in the first place due to the influence of sounds made by the robot and the pump themselves.

### SUMMARY

The present invention is directed to a work assistance method when a worker performs work in a work area where industrial equipment is positioned and an automated guided vehicle travels.

In one aspect of the present invention, a work assistance method includes: (a) constructing an acoustic model to recognize a warning sound emitted when the automated guided vehicle moves; (b) collecting, when the worker wearing a mobile terminal including a display unit, a communication unit, and a sound collecting unit performs work in the work area, sounds using the sound collecting unit; (c) inputting the sounds collected using the sound collecting unit into the acoustic model to determine whether the automated guided vehicle is emitting the warning sound; and (d) causing the mobile terminal to issue a warning when it is determined that the automated guided vehicle is emitting the warning sound in (c).

Even when the worker is not aware of the warning sound emitted by the automated guided vehicle itself, the worker who performs work in the work area can surely recognize the automated guided vehicle by the warning issued by the mobile terminal.

The work assistance method preferably further includes analyzing orientation information of the warning sound using the sound collecting unit when it is determined that the automated guided vehicle is emitting the warning sound in (c), wherein, in (d), the mobile terminal issues the orientation information together with the warning.

The worker can also recognize a positional relationship with the automated guided vehicle.

In another aspect of the present invention, a work assistance method includes: (e) registering a travel path of the automated guided vehicle in the work area; and (f) causing, when the worker wearing a mobile terminal including a display unit, a communication unit, and a sound collecting unit performs work in the work area, the mobile terminal to display the travel path.

The worker who performs work in the work area can surely recognize the automated guided vehicle.

The present invention is also directed to a work assistance system when a worker performs work in a work area where industrial equipment is positioned and an automated guided vehicle travels.

In one aspect of the present invention, a work assistance system includes: a mobile terminal including a display unit, a communication unit, and a sound collecting unit; a storage unit to store an acoustic model to recognize a warning sound emitted when the automated guided vehicle moves; a determination unit to input, into the acoustic model, sounds collected using the sound collecting unit when the worker wearing the mobile terminal performs work in the work area to determine whether the automated guided vehicle is emitting the warning sound; and a warning issuing unit to issue a warning when the determination unit determines that the automated guided vehicle is emitting the warning sound.

Even when the worker is not aware of the warning sound emitted by the automated guided vehicle itself, the worker who performs work in the work area can surely recognize the automated guided vehicle by the warning issued by the mobile terminal.

Preferably, the sound collecting unit analyzes orientation information of the warning sound when the determination unit determines that the automated guided vehicle is emitting the warning sound, and the warning issuing unit issues the orientation information together with the warning.

The worker can also recognize a positional relationship with the automated guided vehicle.

In another aspect of the present invention, a work assistance system includes: a mobile terminal including a display unit, a communication unit, and a sound collecting unit; and a storage unit to store a travel path of the automated guided vehicle in the work area, wherein the mobile terminal displays the travel path when the worker wearing the mobile terminal performs work in the work area.

The worker who performs work in the work area can surely recognize the automated guided vehicle.

It is thus an object of the present invention to allow a worker who performs work in a work area to surely recognize an automated guided vehicle.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating a schematic configuration of a work assistance system according to the present invention;

FIG. 2 is a plan view illustrating one example of a layout of a plurality of substrate processing apparatuses;

FIG. 3 is a plan view of a substrate processing apparatus;

FIG. 4 is a diagram illustrating a schematic configuration of a processing unit;

FIG. 5 is a perspective view illustrating appearance of smart glasses;

FIG. 6 is a block diagram showing functional configurations of the smart glasses, a server, a work assistance terminal, and a controller of a substrate processing apparatus;

FIG. 7 is a flowchart showing the procedure for constructing an acoustic model;

FIG. 8 is a diagram illustrating a recording of sample sounds in a work area;

FIG. 9 is a diagram schematically showing construction of the model;

FIG. 10 is a flowchart showing the procedure for detecting a warning sound emitted by an automated guided vehicle using smart glasses to which the acoustic model has been mounted;

FIG. 11 is a diagram illustrating one example of detection of the warning sound emitted by the automated guided vehicle;

FIG. 12 is a diagram showing one example of a warning message according to a first embodiment;

FIG. 13 is a flowchart showing the procedure for displaying a travel path of the automated guided vehicle for alerting;

FIG. 14 is a diagram illustrating one example of the travel path of the automated guided vehicle in the work area; and

FIG. 15 is a diagram showing one example of a warning message according to a second embodiment.

### DESCRIPTION OF THE PREFERRED EMBODIMENTS

Embodiments of the present invention will be described in detail below with reference to the drawings. An expression indicating a relative or an absolute positional relationship (e.g., “in one direction”, “along one direction”, “parallel”, “orthogonal”, “central”, “concentric”, and “coaxial”) not only exactly indicates the positional relationship but also indicates a state in which an angle or a distance is relatively changed within tolerance or to the extent that a similar function can be obtained below unless otherwise noted. An expression indicating equality (e.g., “same”, “equal”, and “homogeneous”) not only indicates quantitatively exact equality but also indicates a state in which there is a difference within tolerance or to the extent that a similar function can be obtained unless otherwise noted. An expression indicating a shape (e.g., a “circular shape”, a “quadrangular shape”, and a “cylindrical shape”) not only geometrically exactly indicates the shape but also indicates a shape to the extent that a similar effect can be obtained unless otherwise noted, and the shape may have irregularities, a chamfer, and the like. An expression “comprising”, “being provided with”, “being equipped with”, “including”, or “having” one component is not an exclusive expression excluding the presence of the other components. An expression “at least one of A, B, and C” includes “only A”, “only B”, “only C”, “any two of A, B, and C”, and “all of A, B, and C”.

### First Embodiment

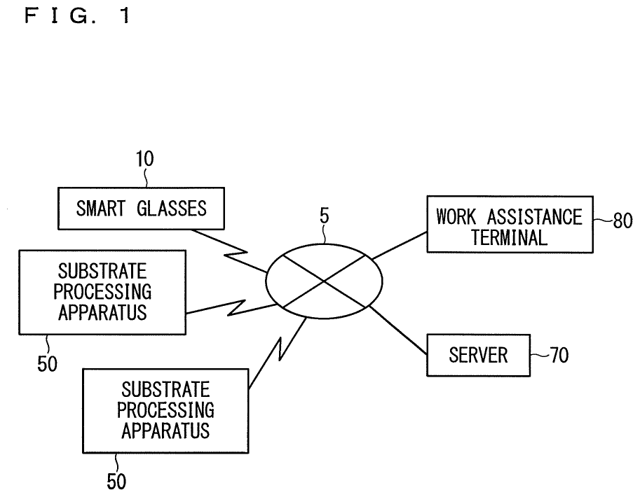

FIG. 1 is a diagram illustrating a schematic configuration of a work assistance system according to the present invention. The work assistance system according to the present invention includes a plurality of substrate processing apparatuses 50, smart glasses 10, a server 70, and a work assistance terminal 80. The smart glasses 10 and controllers of the substrate processing apparatuses 50 are connected to an information communication network 5 (e.g., the internet) by wireless communication. The work assistance terminal 80 and the server 70 are connected to the information communication network 5 by wire.

Information can be transmitted and received among apparatuses connected to the information communication network 5, and, for example, information can be transmitted and received between the smart glasses 10 and the work assistance terminal 80. Wireless or wired connection between each of the apparatuses and the information communication network 5 is not limited to that in the above-mentioned example and may be in an appropriate form (e.g., the work assistance terminal 80 and the information communication network 5 may wirelessly be connected).

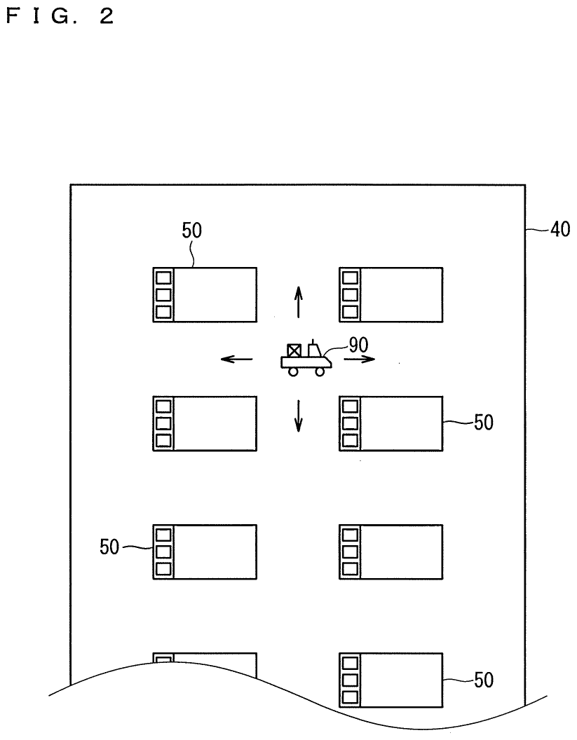

FIG. 2 is a plan view illustrating one example of a layout of the plurality of substrate processing apparatuses 50. As illustrated in FIG. 2, the plurality of substrate processing apparatuses 50 are orderly arranged at regular intervals in the cleanroom 40. The cleanroom 40 is a room which is provided in a semiconductor device manufacturing plant, for example, and in which constant air cleanliness is secured and temperature and humidity are managed. A worker performs work, such as operation and maintenance, of the substrate processing apparatuses 50 in the cleanroom 40. That is to say, the cleanroom 40 where the plurality of substrate processing apparatuses 50 are arranged is a work area in the first embodiment.

An automated guided vehicle (AGV) 90 travels in the cleanroom 40 as the work area. The automated guided vehicle 90 is controlled by pre-programmed software and travels on a floor surface of the cleanroom 40. The automated guided vehicle 90 reads magnetic tape or a marker provided on the floor surface of the cleanroom 40 to be guided, for example. The automated guided vehicle 90 travels according to path data provided from an unillustrated host computer that manages the plurality of substrate processing apparatuses 50, for example. That is to say, the automated guided vehicle 90 travels along a predetermined travel path set in advance. The automated guided vehicle 90 may autonomously travel without being guided.

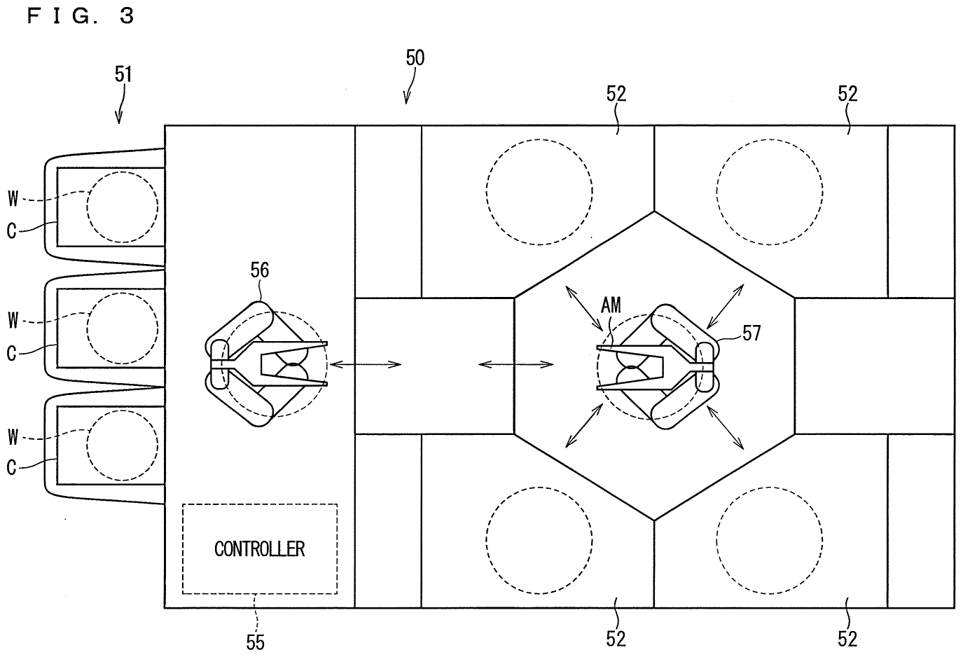

FIG. 3 is a plan view of a substrate processing apparatus 50. The substrate processing apparatus 50 is, for example, a substrate cleaning apparatus of single-substrate type that cleans substrates one by one. The substrate processing apparatus 50 includes an indexer 51, a plurality of processing units 52, a transfer robot 56, and a main transport robot 57.

Carriers C that contain a plurality of substrates W are mounted to the indexer 51. For example, three carriers C can be mounted to the indexer 51. The automated guided vehicle 90 transports the carriers C that contain the plurality of substrates W in the cleanroom 40 and transfers the carriers C to the indexer 51 of the substrate processing apparatus 50. More specifically, the automated guided vehicle 90 transports the carriers C that contain unprocessed substrates W by mounting thereto the substrates W and transfers the carriers C to the indexer 51 of the substrate processing apparatus 50. The automated guided vehicle 90 also receives the carriers C that contain substrates W processed by the substrate processing apparatus 50 from the indexer 51 and transports the carriers C. The carriers C are front opening unified pods (FOUPs) that house the substrates W in enclosed spaces, for example.

The transfer robot 56 is configured to be capable of sliding movement along a direction of arrangement of the plurality of carriers C, raising and lowering operation, pivoting operation, and extending and retracting operation of a hand. The transfer robot 56 takes the unprocessed substrates W out of the carriers C mounted to the indexer 51. The transfer robot 56 also houses the processed substrates W in the carriers C mounted to the indexer 51.

In the first embodiment, three processing units 52 are stacked to constitute a single stack, for example. Four stacks are arranged around the main transport robot 57 of the substrate processing apparatus 50, for example. That is to say, the single substrate processing apparatus 50 includes 12 (=3×4) processing units 52, for example. FIG. 3 illustrates processing units 52 in a single stage included in the same horizontal plane of the four stacks.

The main transport robot 57 positioned at the center of the four stacks is configured to be capable of raising and lowering operation, pivoting operation, and extending and retracting operation of a transport arm AM. The main transport robot 57 can transfer the substrates W to and from all the 12 processing units 52. The main transport robot 57 receives an unprocessed substrate W from the transfer robot 56 and transports the received substrate W into any of the 12 processing units 52. The main transport robot 57 transports a processed substrate W out of the processing unit 52 and transfers the transported substrate W to the transfer robot 56.

The substrate processing apparatus 50 also includes a controller 55. The controller 55 is a general computer and controls operation of the transfer robot 56, the main transport robot 57, and each of the processing units 52 described above provided in the apparatus. The controller 55 includes a touch panel as an input/output interface provided in a wall surface of the apparatus and a communication unit that communicates externally. While the controller 55 is illustrated in the indexer 51 in FIG. 3 for convenience of illustration, a position of the controller 55 is not limited to this position, and the controller 55 is provided at an appropriate position in the substrate processing apparatus 50.

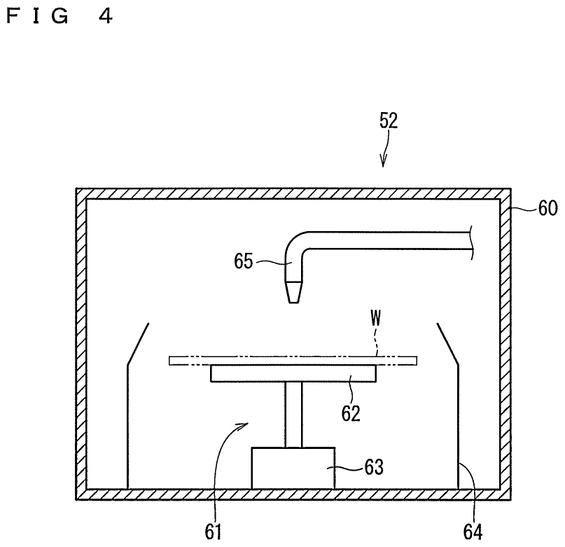

FIG. 4 is a diagram illustrating a schematic configuration of a processing unit 52. The processing unit 52 includes a processing chamber 60, a rotation holding unit 61, and a discharge nozzle 65. The processing chamber 60 is a hollow housing. The rotation holding unit 61, the discharge nozzle 65, and the like are provided in the processing chamber 60. The processing chamber 60 has an unillustrated transport port. The transport port is opened and closed by a shutter. With the transport port being opened, the main transport robot 57 transports the substrate W into and out of the processing chamber 60. The transport port is closed during processing of the substrate W. The processing chamber 60 further includes an unillustrated gas supply mechanism and an unillustrated gas exhaustion mechanism.

The rotation holding unit 61 includes a spin chuck 62 and a spin motor 63. The spin chuck 62 is a substrate holding unit that holds the substrate W in a horizontal position (a position in which a normal to a main surface of the substrate W is along a vertical direction). The spin chuck 62 is a vacuum chuck, for example. The spin chuck 62 has a disc shape having a smaller diameter than the substrate W. The spin chuck 62 adsorptively holds a central portion of a lower surface of the substrate W. With the lower surface of the substrate W adsorptively held by the spin chuck 62, a peripheral edge portion of the substrate W extends outside an outer peripheral edge of the spin chuck 62. The spin chuck 62 may be a chuck in another form, such as a clamping mechanical chuck.

The spin chuck 62 is connected to the spin motor 63 via a motor shaft. That is to say, an upper end of the motor shaft of the spin motor 63 is connected to the central portion of the lower surface of the spin chuck 62. When the spin motor 63 rotates the motor shaft with the substrate W adsorptively held by the spin chuck 62, the substrate W and the spin chuck 62 are rotated in a horizontal plane around a rotational axis along the vertical direction.

A cup 64 is provided to surround the spin chuck 62. The cup 64 can be raised and lowered by an unillustrated raising and lowering mechanism. The cup 64 is cylindrical, and an upper portion of the cup 64 is inclined to be closer to the spin chuck 62 as it extends upward. An inner diameter of an upper end portion of the cup 64, however, is greater than a diameter of the substrate W. An upper end of the cup 64 is at a higher position than the substrate W held by the spin chuck 62 during processing of the substrate W. A liquid splashed by centrifugal force from the substrate W rotated by the spin motor 63 is thus caught by the cup 64 to be retrieved. The liquid retrieved by the cup 64 is drawn off from a drain provided in a bottom of the cup 64. The cup 64 may be a multi-stage cup having a plurality of retrieval ports for respective purposes.

A processing liquid is discharged from the discharge nozzle 65 onto the substrate W held by the spin chuck 62. The processing liquid is a term in a concept including various chemical solutions and de-ionized water. Examples of the chemical solutions include a liquid for etching and a liquid for removal of particles, for example, and specifically include an SC-1 liquid (a mixed solution of ammonium hydroxide, a hydrogen peroxide solution, and de-ionized water), an SC-2 liquid (a mixed solution of hydrochloric acid, a hydrogen peroxide solution, and de-ionized water), hydrofluoric acid, and the like. The discharge nozzle 65 is moved between a processing position above the spin chuck 62 and a standby position outside the cup 64 by an unillustrated drive mechanism. A chemical solution is discharged from the discharge nozzle 65 onto the substrate W held by the spin chuck 62 at the processing position, so that etching of the substrate W progresses, for example. De-ionized water is discharged from the discharge nozzle 65 onto the substrate W, so that de-ionized water rinsing of the substrate W progresses.

The worker who performs work, such as operation and maintenance, on the substrate processing apparatus 50 wears the smart glasses 10. The smart glasses 10 are a kind of a wearable device in the form of a head-mounted display (HMD). The smart glasses 10 are a device to achieve augmented reality (AR) or mixed reality (MR). As the smart glasses 10, “HoloLens®” from Microsoft Corporation can be used, for example.

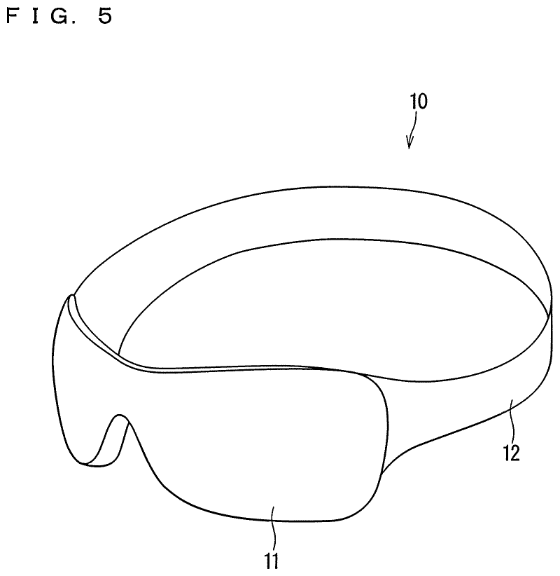

FIG. 5 is a perspective view illustrating appearance of the smart glasses 10. The smart glasses 10 include a visor 11 and a headband 12. The worker wears the headband 12 on the head to wear the smart glasses 10. The worker can adjust a length of the headband 12 according to a size of his/her head. The headband 12 is provided with a power button, a brightness button, a volume button, and the like.

The visor 11 includes various sensors and a display. The display is a see-through holographic lens. That is to say, the display can display a stereoscopic video in a view space of the worker using holograms and transmits light from a real object as with a normal eyeglass lens. The worker wearing the smart glasses 10 can thus view the displayed stereoscopic video while viewing the real object through the display.

The sensors of the visor 11 include a plurality of visible light cameras that mainly capture images ahead of the visor 11, an infrared camera that tracks a gaze of the worker, a depth sensor that measures a distance to a target, an inertial measurement sensor, and the like. The infrared camera measures eye movement of a wearer of the smart glasses 10 to track a gaze. The depth sensor measures the distance to the target by time of flight (ToF), for example. The inertial measurement sensor includes an accelerometer, a gyroscope, a magnetometer, and the like.

A computer including a CPU, memory, and the like is built in the smart glasses 10. The smart glasses 10 are also provided with a wireless communication mechanism, and the computer of the smart glasses 10 is connected to the information communication network 5 using the wireless communication mechanism. The smart glasses 10 are further provided with a microphone array, a speaker, a battery, and the like. The microphone array includes a plurality of spatially arranged microphones (e.g., six microphones arranged at 60° intervals) and can estimate a position and a direction where a sound is emitted by analyzing a difference (e.g., a temporal difference and a phase difference) among sounds measured by the respective microphones.

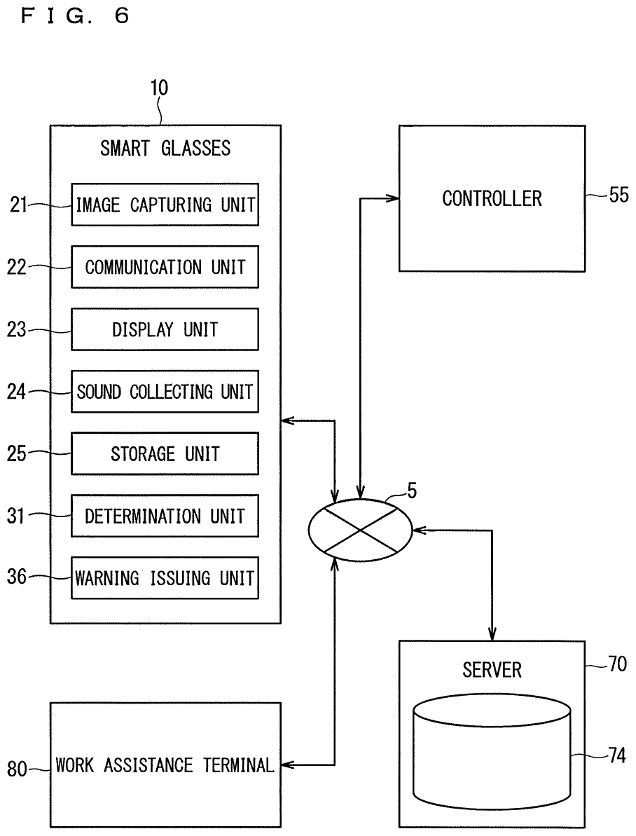

FIG. 6 is a block diagram showing functional configurations of the smart glasses 10, the server 70, the work assistance terminal 80, and the controller 55 of the substrate processing apparatus 50. The smart glasses 10 include an image capturing unit 21, a communication unit 22, a display unit 23, a sound collecting unit 24, and a storage unit 25. The image capturing unit 21 includes the above-mentioned visible light cameras of the visor 11. The image capturing unit 21 includes four visible light cameras that capture images ahead of and diagonally ahead of them, for example, and can capture images in a view range of the worker wearing the smart glasses 10.

The communication unit 22 includes the above-mentioned wireless communication mechanism of the smart glasses 10. The communication unit 22 transmits and receives data to and from the work assistance terminal 80 and the server 70 via the information communication network 5. For close distance, the communication unit 22 can directly transmit and receive data to and from the controller 55 of the substrate processing apparatus 50. That is to say, the communication unit 22 can transmit data and commands to the controller 55 of the substrate processing apparatus 50 directly or via the information communication network 5.

The display unit 23 includes the above-mentioned display of the visor 11. The display unit 23 includes a holographic processing apparatus and displays a stereoscopic video at a predetermined spatial position by holography. The stereoscopic video displayed by the display unit 23 is not limited to a three-dimensional video and may be a two-dimensional video, such as a document.

The sound collecting unit 24 includes the above-mentioned microphone array.

The sound collecting unit 24 collects sounds around the smart glasses 10. The sound collecting unit 24 can analyze and identify orientation information of an emitted sound, that is, a direction from which the sound is propagated through analysis using the microphone array.

The storage unit 25 includes memory and a storage mounted to the smart glasses 10. The memory and the storage of the smart glasses 10 are respectively dynamic random access memory (DRAM) and a universal flash storage (UFS), for example. The storage unit 25 stores therein an application and data to be used by the computer of the smart glasses 10.

The smart glasses 10 also include a determination unit 31 and a warning issuing unit 36. The determination unit 31 and the warning issuing unit 36 are functional processing units that are achieved by the CPU of the smart glasses 10 executing a predetermined processing program. Processing performed by the determination unit 31 and the warning issuing unit 36 will further be described below.

The controller 55 of the substrate processing apparatus 50 controls operation of mechanisms of each of the processing units 52, such as the discharge nozzle 65. The controller 55 of the substrate processing apparatus 50 can communicate with the communication unit 22 of the smart glasses 10 and can control operation of various mechanisms of each of the processing units 52 according to an operation instruction command transmitted from the smart glasses 10.

The work assistance terminal 80 and the server 70 are installed in a plant of a vendor that manufactures the substrate processing apparatus 50 and undertakes maintenance checkup of the substrate processing apparatus 50, for example. The work assistance terminal 80 and the server 70 can communicate with the smart glasses 10 via the information communication network 5. The work assistance terminal 80 and the server 70 can communicate with each other via the information communication network 5.

The work assistance terminal 80 and the server 70 are general computer systems. That is to say, the work assistance terminal 80 and the server 70 each include a CPU as a circuit that performs various types of arithmetic processing, ROM as read only memory that stores a basic program, RAM as random access memory that stores various types of information, a storage unit (e.g., a magnetic disc and an SSD) that stores control software, data, and the like, and a communication unit that performs communication with the information communication network 5.

The work assistance terminal 80 is a computer that is used by a work assistant of the vendor to assist work performed by the worker in the cleanroom 40, for example. The work assistant can transmit various types of information from the work assistance terminal 80 to the smart glasses 10 worn by the worker in the cleanroom 40.

The server 70 is a computer that performs predetermined processing upon request from the smart glasses 10 and the work assistance terminal 80 in the work assistance system according to the present invention. The server 70 includes a storage unit 74 having a relatively large capacity. Data having a large size created by the smart glasses 10 and the work assistance terminal 80 may be stored in the storage unit 74.

A work assistance method using the work assistance system having the above-mentioned configuration will be described next. In the first embodiment, an acoustic model to detect a warning sound emitted by the automated guided vehicle 90 is constructed, and the acoustic model is mounted to the smart glasses 10 to detect the warning sound emitted by the automated guided vehicle 90 in the work area. The automated guided vehicle 90 emits the warning sound to avoid danger during travel in the work area. For example, the automated guided vehicle 90 travels in the work area while playing music. The warning sound is not limited to music and may be a voice, a beep, and the like. The warning sound emitted by the automated guided vehicle 90 typically has a volume that is high enough to allow the worker to hear the warning sound in an environment in which robots, pumps, and the like of the substrate processing apparatuses 50 make noise in the work area.

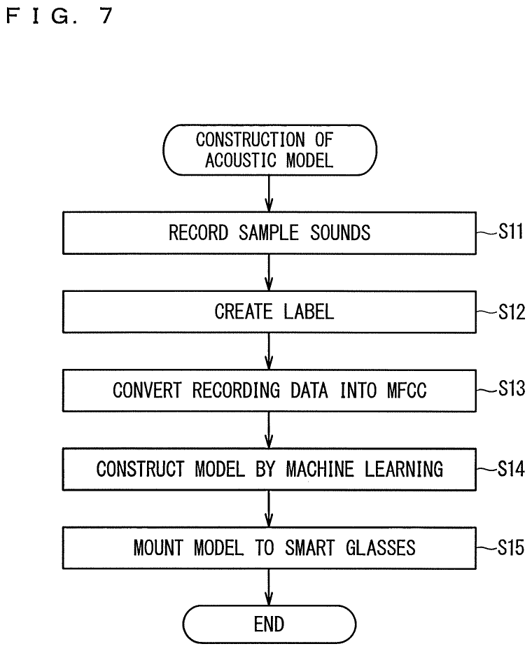

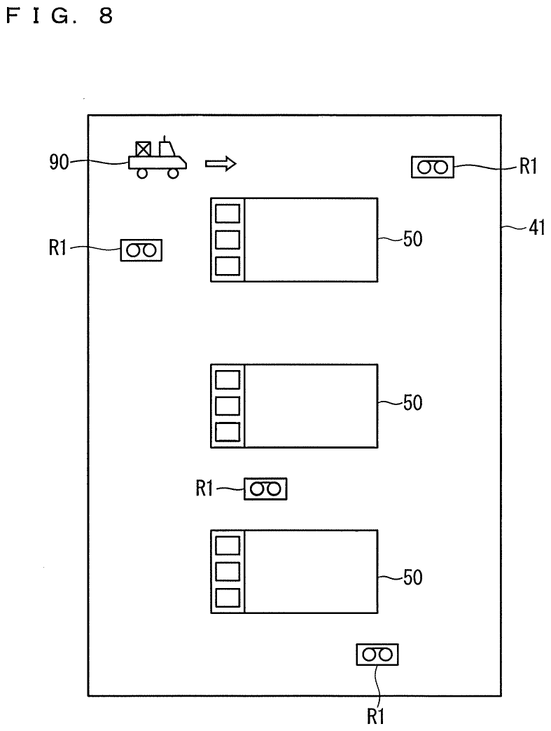

FIG. 7 is a flowchart showing the procedure for constructing the acoustic model. Construction of the acoustic model is a preparation process for the work assistance method according to the present invention. First, sample sounds are recorded in the work area to collect recording data (step S11). FIG. 8 is a diagram illustrating recordings of the sample sounds in the work area. The work area 41 is the cleanroom 40 in the first embodiment. In the work area 41, the plurality of substrate processing apparatuses 50 are arranged, and the automated guided vehicle 90 travels. In step S11, the sample sounds are recorded in the work area 41 at a plurality of recording positions R1. The recordings are made using a predetermined recorder (e.g., an IC recorder).

The recordings are made at each of the plurality of recording positions R1 in the work area 41 both in a state where the automated guided vehicle 90 is emitting the warning sound and in a state where the automated guided vehicle 90 is not emitting the warning sound. The recordings are made at each of the plurality of recording positions R1 not only in the state where the automated guided vehicle 90 is emitting the warning sound but also in the state where the automated guided vehicle 90 is not emitting the warning sound to collect the recording data in a wide variety of environments. That is to say, the recordings made at each of different positions in the work area 41 both in the state where the warning sound is being emitted and in the state where the warning sound is not being emitted enable collection of the recording data in various environments. A wide variety of recording data can enrich learning data in machine learning, which will be described below, and, as a result, accuracy of the constructed acoustic model can be increased.

Next, a label is created for each of a plurality of collected pieces of recording data (step S12). The label according to the present embodiment is information indicating ground truth provided for each piece of recording data. For example, a label “WARNING SOUND BEING EMITTED” is created for recording data in the state where the automated guided vehicle 90 is emitting the warning sound. A label “WARNING SOUND NOT BEING EMITTED” is created for recording data in the state where the automated guided vehicle 90 is not emitting the warning sound. The label is only required to be created by the work assistance terminal 80 or the server 70, for example. The created label becomes training data in machine learning, which will be described below.

Next, each of the plurality of collected pieces of recording data is converted into a mel-frequency cepstrum coefficient (MFCC) (step S13). The MFCC is one type of an acoustic feature. The collected recording data is a time series signal and is inconvenient to be input into the model as it is. The acoustic feature as important information on the recording data is thus extracted and applied to the model. The MFCC is used as the acoustic feature in the first embodiment.

The recording data as the time series signal is converted into the MFCC by a process as described below, for example. First, a Fourier transform is performed on the recording data as the time series signal to acquire a frequency spectrum. A mel filterbank is applied to the frequency spectrum to acquire a mel spectrum. The mel spectrum refers to a spectrum using a frequency axis as a mel scale. The mel scale is a scale based on human hearing that is sensitive to a sound at a low frequency and is insensitive to a sound at a high frequency. A component acquired by applying a discrete cosine transform to the mel spectrum is the MFCC. The MFCC is an acoustic feature in view of human hearing and is thus widely used in a field of voice recognition. The recording data is only required to be converted into the MFCC by the work assistance terminal 80 or the server 70, for example.

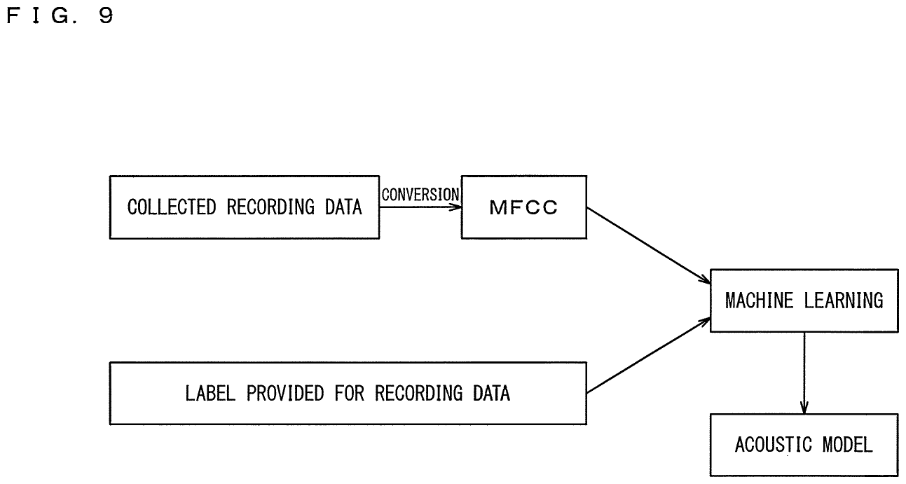

Next, the acoustic model is constructed by machine learning based on the acquired label and the MFCC (step S14). FIG. 9 is a diagram schematically showing construction of the model. The acoustic model is constructed by machine learning using the MFCC acquired by converting the recording data and the label provided for the recording data as learning data. The label is information indicating the ground truth provided for the recording data and becomes the training data in machine learning. That is to say, supervised learning in which an example (the MFCC) and the ground truth (label) are paired is performed in the first embodiment. In the first embodiment, the recording data in various environments is collected for training of the acoustic model to increase accuracy. Machine learning may be performed by the work assistance terminal 80 or the server 70 or may be performed by another computer system, for example. Some MFCCs and labels may be used as validation data and test data for the constructed acoustic model.

In the first embodiment, the acoustic model constructed by machine learning is mounted to the smart glasses 10 (step S15). For example, the acoustic model constructed by the work assistance terminal 80 is stored in the storage unit 25 of the smart glasses 10. The acoustic model is only required to be constructed when the substrate processing apparatuses 50 are installed in the cleanroom 40, for example.

After the acoustic model is constructed and mounted to the smart glasses 10, the smart glasses 10 detect the warning sound emitted by the automated guided vehicle 90 during travel when the worker wearing the smart glasses 10 performs work at an appropriate timing in the work area 41. For example, the smart glasses 10 to which the acoustic model has been mounted detect the warning sound emitted by the automated guided vehicle 90 when the worker wearing the smart glasses 10 performs maintenance or operation on the substrate processing apparatus 50 in the work area 41.

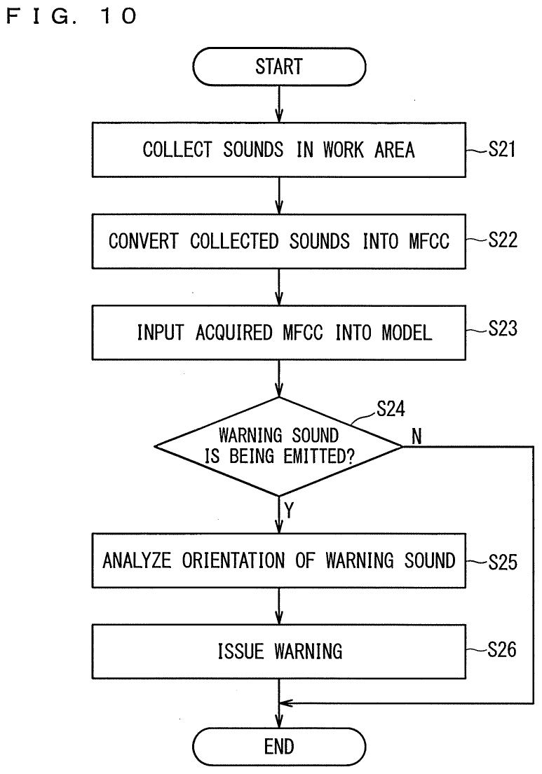

FIG. 10 is a flowchart showing the procedure for detecting the warning sound emitted by the automated guided vehicle 90 using the smart glasses 10 to which the acoustic model has been mounted. First, when the worker wearing the smart glasses 10 performs work in the work area 41, the sound collecting unit 24 of the smart glasses 10 collects sounds in the work area 41 (step S21). The sounds emitted in the work area 41 include operating sounds of the robots, the pumps, and the like of the substrate processing apparatuses 50, a voice of the worker, the warning sound emitted when the automated guided vehicle 90 travels, and the like. Data of the sounds collected by the sound collecting unit 24 is a time series signal having an intensity varying over time.

Next, the data of the sounds collected by the smart glasses 10 is converted into the mel-frequency cepstrum coefficient (MFCC) (step S22). As described above, the MFCC is one type of the acoustic feature and is in particular a feature in view of human hearing. A scheme of converting the data into the MFCC is similar to that in step S13 in the acoustic model construction process (FIG. 7). That is to say, the Fourier transform is performed on the data of the collected sounds to acquire the frequency spectrum, the mel filterbank is applied to the frequency spectrum to acquire the mel spectrum, and the discrete cosine transform is applied to the mel spectrum to acquire the MFCC.

Next, the determination unit 31 of the smart glasses 10 inputs the acquired MFCC into the acoustic model mounted to the smart glasses 10 (step S23). The MFCC as the acoustic feature extracted from the data of the sounds collected in the work area 41 is input into a sufficiently learned acoustic model, so that the acoustic model outputs a result indicating whether the input data includes the warning sound emitted by the automated guided vehicle 90. The determination unit 31 determines whether the automated guided vehicle 90 is emitting the warning sound in the work area 41 based on the result output from the acoustic model (step S24). That is to say, when the acoustic model outputs a result indicating that the input data includes the warning sound, the determination unit 31 determines that the automated guided vehicle 90 is emitting the warning sound in the work area 41. On the other hand, when the acoustic model outputs a result indicating that the input data does not include the warning sound, the determination unit 31 determines that the automated guided vehicle 90 is not emitting the warning sound.

When the determination unit 31 determines that the automated guided vehicle 90 is emitting the warning sound in the work area 41, the sound collecting unit 24 of the smart glasses 10 analyzes the orientation information of the warning sound (step S25). The sound collecting unit 24 includes the microphone array including the plurality of spatially arranged microphones and can analyze a direction from which the warning sound is propagated.

The sound collecting unit 24 further detects a gradual increase or decrease in volume of the warning sound, and, based on a result of detection, the smart glasses 10 determine whether the automated guided vehicle 90 is approaching or is traveling away. Specifically, when the volume of the warning sound collected by the sound collecting unit 24 gradually increases, the smart glasses 10 determine that the automated guided vehicle 90 is approaching. On the other hand, when the volume of the warning sound gradually decreases, the smart glasses 10 determine that the automated guided vehicle 90 is traveling away.

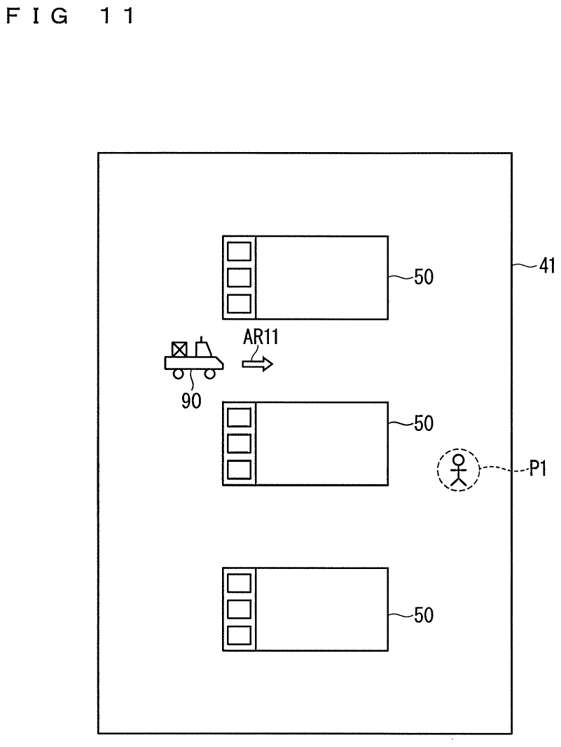

FIG. 11 is a diagram illustrating one example of detection of the warning sound emitted by the automated guided vehicle 90. The worker wearing the smart glasses 10 to which the acoustic model has been mounted is performing work at a position P1 in the work area 41. In this case, the automated guided vehicle 90 is traveling in a direction indicated by an arrow AR11 in FIG. 11. The automated guided vehicle 90 is emitting the warning sound to avoid danger during travel in the work area 41. The smart glasses 10 worn by the worker input the MFCC extracted from the data of the collected sounds into the acoustic model to detect the warning sound emitted by the automated guided vehicle 90. The smart glasses 10 detect the warning sound emitted by the automated guided vehicle 90 propagated from the right and ahead of the worker and detect a gradual increase in volume of the warning sound. As a result, the smart glasses 10 detect approach of the automated guided vehicle 90 from the right and ahead of the worker.

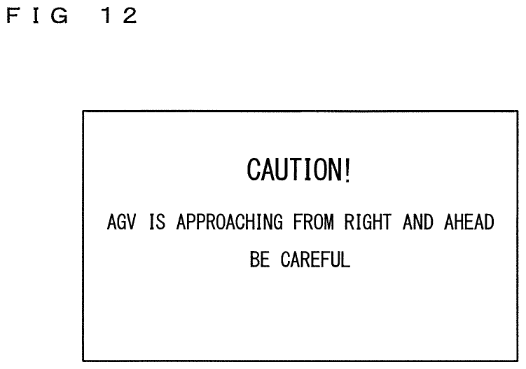

The warning issuing unit 36 of the smart glasses 10 then issues a warning (step S26). Specifically, the warning issuing unit 36 causes the display unit 23 to display a warning screen as a stereoscopic video, for example. FIG. 12 is a diagram showing one example of the warning screen caused to be displayed by the warning issuing unit 36. As shown in FIG. 12, a warning on the presence of the automated guided vehicle 90 as well as the orientation information of the automated guided vehicle 90 are displayed in the warning screen. The orientation information includes information on a direction of the automated guided vehicle 90 relative to the worker and whether the automated guided vehicle 90 is approaching or is traveling away. That is to say, a message indicating that the automated guided vehicle 90 is approaching from the right and ahead is displayed as a warning message in an example of FIG. 11. A warning screen including a message as in FIG. 12 is displayed, so that the worker can recognize the approach of the automated guided vehicle 90 from the right and ahead and is to pay attention to the automated guided vehicle 90. As a result, safety of the worker can be secured. The warning issued by the warning issuing unit 36 is not limited to the warning screen, and a warning voice may be emitted in place of or in addition to the warning screen, or annotation in which the direction from which the automated guided vehicle 90 is approaching is colored may be displayed.

In the first embodiment, the acoustic model to detect the warning sound emitted by the automated guided vehicle 90 is constructed in advance and is mounted to the smart glasses 10. In constructing the acoustic model, the recordings are made in the work area 41 both in the state where the automated guided vehicle 90 is emitting the warning sound and in the state where the automated guided vehicle 90 is not emitting the warning sound to collect the recording data in various environments, and the MFCC is extracted as the acoustic feature from the recording data to be used as the learning data in machine learning. Machine learning is performed based on a wide variety of learning data, so that accuracy of the acoustic model can be improved.

In the first embodiment, the MFCC extracted from the sounds collected by the smart glasses 10 worn by the worker performing work is input into the acoustic model to determine whether the automated guided vehicle 90 is emitting the warning sound. The warning issuing unit 36 of the smart glasses 90 issues the warning when it is determined that the automated guided vehicle 90 is emitting the warning sound.

The automated guided vehicle 90 emits the warning sound originally to notify the nearby worker of the presence of the automated guided vehicle 90 to avoid danger. When the automated guided vehicle 90 keeps emitting the warning sound in an environment in which the substrate processing apparatuses 50 and the like make noise, however, the worker concentrating on work might get used to the warning sound and sometimes cannot recognize the approach of the automated guided vehicle 90. According to the present embodiment, even if the worker gets used to the warning sound emitted by the automated guided vehicle 90, the smart glasses 10 issue a new warning, so that the worker can surely recognize the presence of the automated guided vehicle 90 again by the stimulus.

Furthermore, in the first embodiment, the smart glasses 10 analyze the orientation information of the warning sound when it is determined that the automated guided vehicle 90 is emitting the warning sound. The orientation information obtained as a result of analysis is displayed to be included in the warning screen. The orientation information includes the information on the direction of the automated guided vehicle 90 viewed from the worker and whether the automated guided vehicle 90 is approaching or is traveling away. The worker can thus more accurately recognize a positional relationship with the automated guided vehicle 90.

### Second Embodiment

A second embodiment of the present invention will be described next. A work assistance system according to the second embodiment has the same configuration as the work assistance system according to the first embodiment. The warning sound emitted by the automated guided vehicle 90 is detected in the first embodiment, whereas the travel path of the automated guided vehicle 90 registered in advance is displayed to alert the worker in the second embodiment.

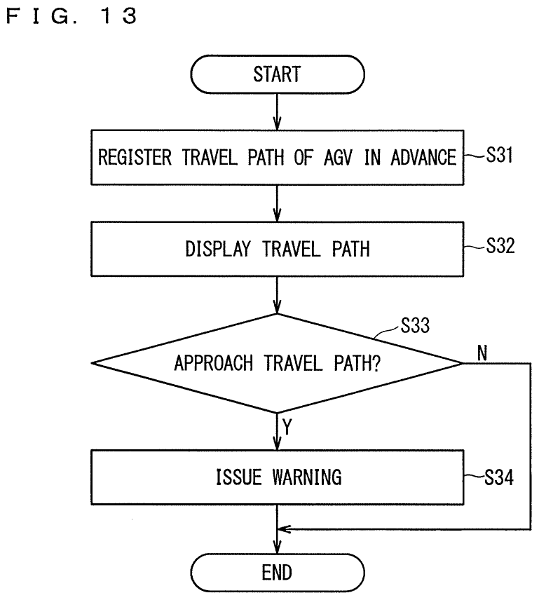

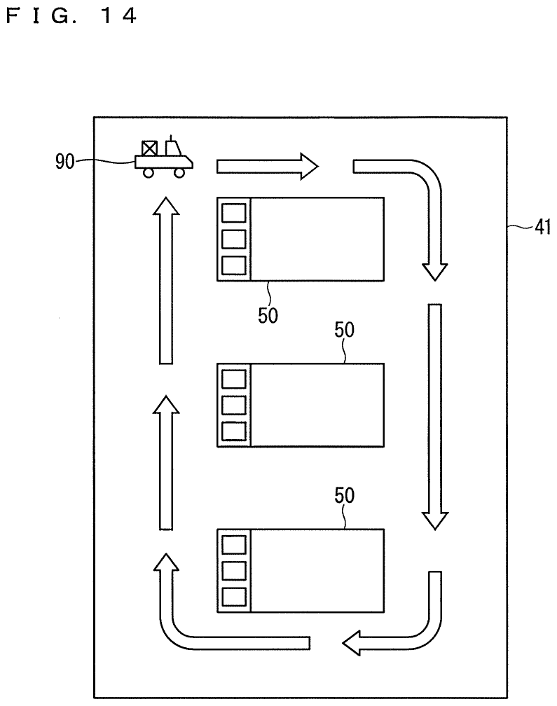

FIG. 13 is a flowchart showing the procedure for displaying the travel path of the automated guided vehicle 90 for alerting. The travel path of the automated guided vehicle 90 in the cleanroom 40 as the work area 41 is determined in advance based on processing schedules of the plurality of substrate processing apparatuses 50 arranged in the cleanroom 40 and the like. Data of the travel path of the automated guided vehicle 90 in the work area 41 is registered in advance in the storage unit 74 of the server 70, for example (step S31). FIG. 14 is a diagram illustrating one example of the travel path of the automated guided vehicle 90 in the work area 41.

When the worker wearing the smart glasses 10 performs work in the work area 41, the display unit 23 of the smart glasses 10 displays the travel path of the automated guided vehicle 90 (step S32). Specifically, when the worker wearing the smart glasses 10 enters the work area 41, for example, the smart glasses 10 read the travel path of the automated guided vehicle 90 registered in the storage unit 74 of the server 70, and the display unit 23 displays the travel path as in FIG. 14 as a stereoscopic video. The worker can thus recognize the travel path of the automated guided vehicle 90 and is to pay attention to the automated guided vehicle 90. As a result, safety of the worker can be secured.

The smart glasses 10 monitor whether the worker is approaching the travel path of the automated guided vehicle 90 (step S33). Specifically, whether a position of the worker wearing the smart glasses 10 is within a predetermined range from the travel path of the automated guided vehicle 90 is determined. As a scheme of identifying the position of the worker, the smart glasses 10 perform scanning in the work area 41 to create a spatial mesh, and the spatial mesh is compared with a spatial mesh created in the past to identify the position of the worker, for example. As operation performed by the smart glasses 10 to create the spatial mesh, the worker wearing the smart glasses 10 is only required to turn on a scan mode. The created spatial mesh is represented by a large number of triangular meshes. Various shapes including a curved surface and a flat surface are represented by a set of a large number of connected triangles. A complex shape including irregularities is represented by triangles at a high density, and, on the other hand, a flat shape is represented by triangles at a relatively low density.

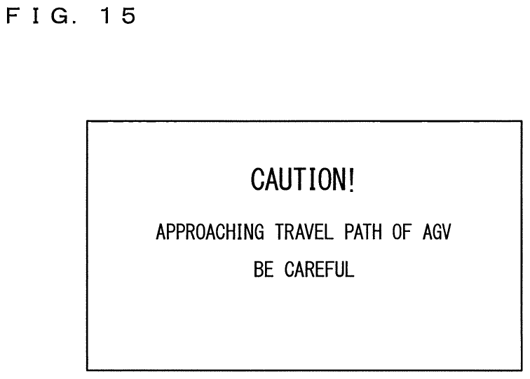

When the position of the worker identified by comparison of the spatial mesh is within the predetermined range from the travel path of the automated guided vehicle 90, the worker is too close to the travel path, so that the warning issuing unit 36 of the smart glasses 10 issues the warning (step S34). Specifically, the warning issuing unit 36 causes the display unit 23 to display a warning screen as a stereoscopic video, for example. FIG. 15 is a diagram showing one example of the warning screen according to the second embodiment caused to be displayed by the warning issuing unit 36. As shown in FIG. 15, a message indicating that the worker is too close to the travel path of the automated guided vehicle 90 is displayed as a warning message in the warning screen. The warning screen including a message as in FIG. 15 is displayed, so that the worker can recognize that the worker is too close to the travel path of the automated guided vehicle 90 and is to pay attention to the automated guided vehicle 90. As a result, safety of the worker can be secured. As in the first embodiment, the warning issued by the warning issuing unit 36 is not limited to the warning screen, and a warning voice may be emitted in place of or in addition to the warning screen, or annotation in which the travel path of the automated guided vehicle 90 is colored may be displayed.

In the second embodiment, when the worker wearing the smart glasses 10 performs work in the work area 41, the smart glasses 10 display the travel path of the automated guided vehicle 90 registered in advance. The worker who performs work in the work area 41 can thus recognize the automated guided vehicle 90.

Furthermore, when the worker wearing the smart glasses 10 approaches the predetermined range from the travel path of the automated guided vehicle 90, the smart glasses 10 issue the warning. The worker can thus surely recognize that the worker is too close to the travel path of the automated guided vehicle 90.

### <Modifications>

While the embodiments of the present invention have been described above, various modifications other than those described above can be made on the present invention without departing from the scope of the present invention. For example, while the MFCC is extracted as the acoustic feature from the recording data and is used as the learning data in machine learning in the first embodiment, the acoustic feature is not limited to the MFCC, and the frequency spectrum acquired by performing the Fourier transform on the recording data may be used as the acoustic feature. In this case, the acoustic model is constructed by machine learning using the frequency spectrum as the learning data in step S14, and the frequency spectrum acquired from the data of the collected sounds is input into the acoustic model in step S23. Alternatively, the mel spectrum acquired by applying the mel filterbank to the frequency spectrum may be used as the acoustic feature. Alternatively, the data of the sounds as the time series signal may be used as it is to construct the acoustic model without extracting the acoustic feature.

While the automated guided vehicle 90 approaches the worker in the first embodiment, the smart glasses 10 issue a warning upon detection of the warning sound emitted by the automated guided vehicle 90 even when the automated guided vehicle 90 is traveling away from the worker. That is to say, the smart glasses 10 issue the warning also upon detection of a gradual decrease in volume of the warning sound emitted by the automated guided vehicle 90. The worker can thus surely recognize the presence of the automated guided vehicle 90.

While the orientation information includes the information on the direction of the automated guided vehicle 90 relative to the worker and whether the automated guided vehicle 90 is approaching or is traveling away in the first embodiment, the orientation information may include, in addition to the information, information on a distance from the worker to the automated guided vehicle 90. The distance from the worker to the automated guided vehicle 90 can be calculated from the volume of the warning sound collected by the sound collecting unit 24.

While the constructed acoustic model is mounted to the smart glasses 10 in the first embodiment, the acoustic model may not be mounted to the smart glasses 10 and may be stored in the server 70 or the work assistance terminal 80 and be used by the smart glasses 10. The data of the travel path of the automated guided vehicle 90 may directly be registered on the smart glasses 10 in the second embodiment.

The first embodiment and the second embodiment may be combined together.

That is to say, the smart glasses 10 may detect the warning sound emitted by the automated guided vehicle 90 while displaying the travel path of the automated guided vehicle 90. The worker can thus more surely recognize the automated guided vehicle 90.

While the worker uses the smart glasses 10 in each of the above-mentioned embodiments, the smart glasses 10 may not be used, and a mobile terminal, such as a tablet and a smartphone, may be used in place of the smart glasses 10. That is to say, the mobile terminal is only required to include the display unit, the communication unit, the sound collecting unit, and the like. Use of the tablet or the like, however, occupies the hand of the worker holding it, so that it is preferable to use a wearable, such as the smart glasses 10.

The substrate processing apparatus 50 installed in a normal area in the cleanroom 40 is not limited to the substrate cleaning apparatus and may be any apparatus that performs predetermined processing on a substrate, such as a heat treatment apparatus, an exposure apparatus, a coating development apparatus, a measurement apparatus, and an inspection apparatus. When the substrate processing apparatus 50 is the substrate cleaning apparatus, the substrate cleaning apparatus may be a cleaning apparatus of single-substrate type that cleans substrates one by one or may be a cleaning apparatus of batch type that collectively cleans a plurality of substrates.

Furthermore, a target of work assistance technology according to the present invention is not limited to the substrate processing apparatus and may be any industrial equipment that performs any processing. Examples of such industrial equipment include a printing apparatus, a deposition apparatus, a medical apparatus, a visual inspection apparatus, and the like.

While the invention has been shown and described in detail, the foregoing description is in all aspects illustrative and not restrictive. It is therefore understood that numerous modifications and variations can be devised without departing from the scope of the invention.

What is claimed is:

1. A work assistance method when a worker performs work in a work area where industrial equipment is positioned and an automated guided vehicle travels, the work assistance method comprising the steps of:
(a) constructing an acoustic model to recognize a warning sound emitted when the automated guided vehicle moves;
(b) collecting, when the worker wearing a mobile terminal including a display unit, a communication unit, and a sound collecting unit performs work in the work area, sounds using the sound collecting unit;
(c) inputting the sounds collected using the sound collecting unit into the acoustic model to determine whether the automated guided vehicle is emitting the warning sound; and
(d) causing the mobile terminal to issue a warning when it is determined that the automated guided vehicle is emitting the warning sound in said step (c).

2. The work assistance method according to claim 1, wherein
said step (a) comprises:
(a-1) making recordings in the work area in a state where the automated guided vehicle is emitting the warning sound and in a state where the automated guided vehicle is not emitting the warning sound;
(a-2) acquiring an acoustic feature from recording data collected in said step (a-1); and
(a-3) constructing the acoustic model by machine learning based on a label provided for the recording data collected in said step (a-1) and the acoustic feature.

3. The work assistance method according to claim 2, wherein
the acoustic feature is a mel-frequency cepstrum coefficient, and
in said step (c), the mel-frequency cepstrum coefficient extracted from the sounds collected using the sound collecting unit is input into the acoustic model.

4. The work assistance method according to claim 1, further comprising
analyzing orientation information of the warning sound using the sound collecting unit when it is determined that the automated guided vehicle is emitting the warning sound in said step (c), wherein
in said step (d), the mobile terminal issues the orientation information together with the warning.

5. The work assistance method according to claim 1, wherein
in said step (d), the mobile terminal displays a warning screen and emits a warning voice.

6. The work assistance method according to claim 1, wherein
the industrial equipment is a substrate processing apparatus that performs predetermined processing on a substrate, and
the mobile terminal is smart glasses.

7. A work assistance method when a worker performs work in a work area where industrial equipment is positioned and an automated guided vehicle travels, the work assistance method comprising the steps of:
(e) registering a travel path of the automated guided vehicle in the work area; and
(f) causing, when the worker wearing a mobile terminal including a display unit, a communication unit, and a sound collecting unit performs work in the work area, the mobile terminal to display the travel path.

8. The work assistance method according to claim 7, further comprising
(g) causing the mobile terminal to issue a warning when the worker approaches a predetermined range from the travel path.

9. The work assistance method according to claim 8, wherein
in said step (g), the mobile terminal displays a warning screen and emits a warning voice.

10. The work assistance method according to claim 7, wherein
the industrial equipment is a substrate processing apparatus that performs predetermined processing on a substrate, and
the mobile terminal is smart glasses.

11. A work assistance system when a worker performs work in a work area where industrial equipment is positioned and an automated guided vehicle travels, the work assistance system comprising:
a mobile terminal including a display unit, a communication unit, and a sound collecting unit;
a storage unit to store an acoustic model to recognize a warning sound emitted when the automated guided vehicle moves;
a determination unit to input, into the acoustic model, sounds collected using the sound collecting unit when the worker wearing the mobile terminal performs work in the work area to determine whether the automated guided vehicle is emitting the warning sound; and
a warning issuing unit to issue a warning when the determination unit determines that the automated guided vehicle is emitting the warning sound.

12. The work assistance system according to claim 11, wherein
the acoustic model is constructed by machine learning based on an acoustic feature and a label, the acoustic feature being acquired from recording data collected by making recordings in the work area in a state where the automated guided vehicle is emitting the warning sound and in a state where the automated guided vehicle is not emitting the warning sound, the label being provided for the recording data.

13. The work assistance system according to claim 12, wherein
the acoustic feature is a mel-frequency cepstrum coefficient, and
the determination unit inputs the mel-frequency cepstrum coefficient extracted from the sounds collected using the sound collecting unit into the acoustic model.

14. The work assistance system according to claim 11, wherein
the sound collecting unit analyzes orientation information of the warning sound when the determination unit determines that the automated guided vehicle is emitting the warning sound, and
the warning issuing unit issues the orientation information together with the warning.

15. The work assistance system according to claim 11, wherein
the warning issuing unit displays a warning screen and emits a warning voice.

16. The work assistance system according to claim 11, wherein
the industrial equipment is a substrate processing apparatus that performs predetermined processing on a substrate, and
the mobile terminal is smart glasses.

17. A work assistance system when a worker performs work in a work area where industrial equipment is positioned and an automated guided vehicle travels, the work assistance system comprising:
a mobile terminal including a display unit, a communication unit, and a sound collecting unit; and
a storage unit to store a travel path of the automated guided vehicle in the work area, wherein
the mobile terminal displays the travel path when the worker wearing the mobile terminal performs work in the work area.

18. The work assistance system according to claim 17, further comprising
a warning issuing unit to issue a warning when the worker approaches a predetermined range from the travel path.

19. The work assistance system according to claim 18, wherein
the warning issuing unit displays a warning screen and emits a warning voice.

20. The work assistance system according to claim 17, wherein
the industrial equipment is a substrate processing apparatus that performs predetermined processing on a substrate, and
the mobile terminal is smart glasses.
